(19) United States
(12) Patent Application Publication
(10) Pub. No.: US 2007/0269569 A1
(43) Pub. Date: Nov. 22, 2007

(54) REDUCED-CALORIE ICING COMPOSITIONS COMPRISING INULIN

(76) Inventors: Michael P. Bashor, St. Louis Park, MN (US); Thomas J. Fort, Plymouth, MN (US); Janet L. Boyle, St. Paul, MN (US)

Correspondence Address: GENERAL MILLS, INC., P.O. BOX 1113, MINNEAPOLIS, MN, 55440, US

(21) Appl. No.: 11/747,266

(22) Filed: May 11, 2007

Related U.S. Application Data
(60) Provisional application No. 60/747,875, filed on May 22, 2006.

(51) Int. Cl. A23L 1/236

(52) U.S. Cl. 426/548

(57) ABSTRACT

The invention relates to a reduced-calorie icing composition comprising inulin. The inulin replaces at least a portion of the sugar that would otherwise be present in the icing composition providing a reduced-calorie icing having about 3.7 calories/gram or less. The reduced-calorie icing composition is capable of being dispensed by hand from a flexible pouch at a frozen temperature yet is not runny at room temperature.

### CROSS-REFERENCE TO RELATED APPLICATIONS

This application claims the benefit of priority under 35 U.S.C. 119(e)(1) of a provisional patent application Ser. No. 60/747,875, filed May 22, 2006, which is incorporated herein by reference in its entirety.

### FIELD

The invention relates to a reduced-calorie icing composition that comprises inulin which replaces at least a portion of the sugar that would otherwise be present in the composition.

### BACKGROUND

Toppings such as frostings, particulates, icings, and any combination of those, have been used for years to add aesthetic value as well as enhance moisture or sweetness of baked goods or pastries. Frostings, in general, are highly viscous, and generally applied to a baked or other edible product by scooping it out of a container, squeezing it out of a pastry (piping) bag, or pushing it out of a frosting device such as a frosting ‘gun.’ Such frosting compositions, must be flowable and not frozen for the frosting to be applicable and manipulatable. Icing is generally a less viscous product used for filings, or as coating or topping, and also useful for decorating and/or enhancing the taste of a product. Icing compositions are provide in a variety of formats, including pre-packaged for smaller volume use, or it can be provided in larger containers for high volume users or manufacturing processes.

For end user convenience and rapid preparation, pastry products are often pre-baked and sold to the consumer in a frozen state. To prepare the pastry, the consumer thaws and heats the pastry to a desired temperature using a heating device, for example, a toaster. In many instances, a container (e.g., a pouch) of icing is provided with the frozen pastry for application to the warned pastry. Typically, the pouch of icing is packaged with the pastry and remains substantially frozen until the pastry is removed from the freezer to be prepared. Because it is typically contained in the same package as the frozen pastry, it is subjected to a wide variety of temperature conditions including, for example, conditions ranging from frozen to thawed.

Although icings have been developed that can be used under broad temperature-ranges (see, e.g., U.S. Pat. No. 4,397,176), a reduced-calorie version of such icings is desirable. For example, reduced-calorie icing compositions allow the manufacturer of frozen pastry products to offer a reduced-calorie pastry product or to provide a product having an increased portion of icing without increasing the total calories that are contributed to the product by the icing.

### BRIEF SUMMARY OF THE INVENTION

The invention provides reduced-calorie icing compositions that comprise inulin. The reduced-calorie icing compositions can be dispensed by hand from a flexible pouch when frozen, yet are not runny at room temperature. The icing compositions can also be applied using other devices, even when frozen. In many embodiments, the reduced-calorie icing compositions have about 3.7 calories/gram or less.

In some embodiments, the reduced-calorie icing composition comprises about 10% wt. to about 15% wt. inulin; about 30% wt. to about 55% wt. sugar; about 0.009% wt. to about 0.027% wt. xanthan gum; about 8% wt. to about 20% wt. water; and about 12% to about 20% wt. total fat. Other ingredients include, for example, corn syrup solids, salt, high fructose corn syrup, flavoring (e.g., vanilla), and polysorbate 60. In an exemplary embodiment, the reduced-calorie icing composition comprises about 11% wt. to about 13% wt. inulin; about 45% wt. to about 46% wt. sugar; about 0.010% wt. to about 0.015% wt. xanthan gum; about 12% wt. to about 14% wt. water; and about 14% wt. to about 16% wt. total fat. In some embodiments, the weight ratio of inulini to water in the reduced-calorie icing ranges from about 10:8 to about 15:20.

In some embodiments, the fat component of the reduced-calorie icing comprises a mixture of liquid oil and hydrogenated shortening. Typically, the ratio of liquid oil to liquid oil plus hydrogenated shortening is in the range of about 0.26:1 to about 0.43 to 1. In some embodiments, the hydrogenated shortening has a Wiley melting point of about 115° F.±5° F. and a solids fat index (SFI) of from about 23% to about 29% wt. at 50° F.; about 17% to about 23% wt. at 70° F.; about 12% to about 16% at 92° F.; and about 8% to about 12% at 104° F.

In some embodiments, the reduced-calorie icing composition has a density of about 0.95 to about 1.15 grams/cm³. In other embodiments, the reduced-calorie icing composition has a density that is greater than about 1.0 grams/cm³, for example, from about 1.0 to about 1.05 grams/cm³.

In some embodiments, the reduced-calorie icing composition can be dispensed by hand from a flexible pouch at a frozen temperature yet is not runny at room temperature. For example, in some embodiments, the icing composition has a viscosity of about 120,000 cps at 4° C. and a viscosity of about 49,000 cps at 21° C., when measured at a shear rate of 100 seconds⁻¹.

In another aspect, the invention provides a food product comprising: (a) a pre-cooked pastry; and (b) a flexible pouch at least partially filled with a reduced-calorie icing composition of the invention. Examples of pre-cooked pastries include toaster pastries.

### DETAILED DESCRIPTION OF THE INVENTION

The invention relates to reduced-calorie icing compositions comprising inulin. The inulin replaces at least a portion of the sugar that would otherwise be present in the icing composition. Because inulin is not digested in the gastrointestinal tract, the replacement of sugar with inulin provides an icing composition having reduced calories per gram. In many embodiments, the reduced-calorie icing compositions have about 3.7 calories per gram or less. Icing compositions of the invention are flowable at frozen conditions yet are not runny at room temperature.

Reduced-calorie icing compositions of the invention comprise inulin. Inulin is a fructan-type carbohydrate, consisting mainly of fructose units, which occurs in many plants as a reserve carbohydrate. Inulin may also be produced by certain bacteria and can also be produced enzymatically from sucrose. Inulin occurs naturally as a polydisperse mixture of carbohydrate molecules consisting mainly of fructosyl units forming chains in which the fructosyl units are linked to one another by beta-(2-1) bonds. The beta-(2-1) bonds that are present in inulin prevent it from being digested in the upper gastrointestinal tract, thereby resulting in reduced caloric value. The mainly linear chains may include one or more side chains of fructosyl units. Inulin molecules from plant origin typically contain one terminal glucosyl unit. Accordingly, inulin molecules from plant origin can be represented by the formula GFₙ, where G represents a terminal glucosyl unit, F represents a fructosyl unit, and n represent the number of fructosyl units linked to one another.

Inulin may be characterized, for example, by its average degree of polymerization (DP_{Ave}). This is the value which corresponds to the total number of saccharide units (G and F units) in a given inulin sample divided by the total number of inulin molecules in the sample, without taking into account the monosaccharides glucose (G) and fructose (F) and the disaccharide sucrose (GF) which are possibly present in the sample. Inulin from plant sources is typically a polydisperse mixture of predominately linear chains with a degree of polymerization (DP) ranging from 2 to about 100. Plant inulin has an average degree of polymerization (DP_{Ave}) which depends, for example, upon the plant source and on the harvest, storage, and processing conditions.

Inulin from plant sources is commonly manufactured from roots of Chicory (Cichorium intybus), but also can be obtained from tubers of Jerusalem artichoke (Helianthus tuberosus) and from the head of the Blue Agave plant. Inulin can be readily extracted from the plant sources and purified according to conventional techniques. Inulin from chicory is typically a polydisperse mixture of slightly branched chains with a (DP) ranging from 2 to about 70 and a (DP_{Ave}) ranging from about 10 to about 12. In many embodiments of the invention, the inulin comprises short chain inulin molecules, for example, having an average degree of polymerization (DP_{Ave}) of about 20 or less.

When added to an icing composition, inulin may thicken the icing composition such that it may become too viscous and dense. Because of this property, the amount of both inulin and water in the icing composition are controlled to provide an icing composition having the desired viscosity and density. For example, in some embodiments, the weight ratio of inulin to water (wt. inulin: wt. water) ranges from about 10:8 to about 15:20. The thickening effect of inulin on the icing formulation may also be controlled, for example, by the order of addition of the ingredients when preparing the icing composition. For example, the thickening effect of inulin may be reduced by pre-mixing the water and powdered sugar for about 1 minute or more before adding the inulin. In many embodiments, inulin is added to the icing composition in an amount ranging from about 10% wt. to about 15% wt. In exemplary embodiments, the inulin is added to the icing composition in an amount ranging from about 11% wt. to about 13% wt. Suitable inulin can be obtained commercially under the trade designation “FRUTAFIT CLR” (from Sensus Co.) or “RAFTILINE” (from Orafiti, Malvern Pa.).

Reduced-calorie icing compositions of the invention comprise a reduced amount of sugar as compared to prior compositions. In some embodiments, the sugar is present in the icing composition in an amount ranging from about 30% wt. to about 55% wt, more typically ranging from about 40% wt. to about 55% wt., and most typically ranging from about 45% wt. to about 46% wt. In exemplary embodiments, the sugar is powdered sugar, for example, powdered sugar having a particle size within the range of about 6× to about 12×.

Reduced-calorie icing compositions of the invention comprise a gum, for example, xanthan gum, for thickening and to control water and retard ice recrystallization. Xanthan gum is an exocellular heteropolysaccharide that is produced by the microorganism Xanthornonas campestris by a fermentation process. Xanthan gum consists primarily of a 1,4-linked β-D-glucose backbone with side chains containing two mannoses and one glucuronic acid at the C-3 position on every other glucose. Xanthan gum is a non-gelling, water-soluble, anionic polyelectrolyte.

In many embodiments, the xanthan gum is present in the icing composition in an amount ranging from about 0.009% to about 0.027% wt., more typically ranging from about 0.010% wt. to about 0.015% wt., and most typically ranging from about 0.011% wt. to about 0.013% wt. Suitable xanthan gums are commercially available under the trade designations “KELTROL F” (from CP Kelco U.S., Inc.); “NOVAXAN” (from ADM Co.); “TICAXAN XANTHAN 200 POWDER” (from TIC Gums Inc.); and “GRINDSTED XANTHAN 200” (from Danisco Co., Copenhagen, Denmark).

Water is present in reduced-calorie icing compositions of the invention to provide the composition with the desired viscosity. The precise amount of water depends on factors known to those skilled in the art. For example, the amount of water should not be so high that the icing composition has an undesirably low viscosity or is stringy. The amount of water should not be so low that the dough composition is too dry. Water is typically present in icing compositions of the invention in an amount ranging from about 8% wt. to about 20% wt.

Reduced-calorie icing compositions of the invention comprise a source of fat. The total fat content of the icing composition typically ranges from about 12% wt. to about 20% wt. of the icing composition, more typically ranging from about 13% wt. to about 17% wt. In an exemplary embodiment, the total fat content is about 14% wt. If the total fat content is greater than the upper percentage limit, the product finrness may increase and spreadability may decrease to an undesirable level. Conversely, it the total fat content is less than about the minimum level specified herein, the product may not have optimum clinging properties on a pastry surface and may be too runny.

Typically, the fat content is provided as a combination of a liquid shortening and a plastic shortening, for example, having a ratio of liquid shortening to liquid shortening plus plastic shortening within the range of from about 0.26:1 to about 0.43:1. The liquid shortening plus the plastic shortening provide the total fat content.

Useful liquid shortenings or oil ingredients are characterized by being high in mono or polyunsaturates and typically contain little or no emulsifiers. Representative examples, include unsaturated vegetable oils, such as cottonseed oils, soybean oil, coconut oil, rapeseed oil, peanut oil, olive oil, palm oil, palm kernel oils, sunflower seed oil, wallflower oil, and the like. In an exemplary embodiment, the shortening is winterized soybean oil.

Useful solid shortening or fat can be any of those commercially available on the market as plastic shortenings. As those skilled in the art know, such plastic shortenings generally are prepared from hydrogenated oils, often with added emulsifiers. An exemplary plastic shortening has a monoglyceride content of 3.8%±0.2% wt., a Wiley melting point of 115° F.±2° F., and a solids fat index (SFI) as shown in TABLE A.

TABLE A

| Temperature | SFI |
|---|---|
| (° F.) | (% by wt.) |
| 50 | 26 ± 3 |
| 70 | 20 ± 3 |
| 92 | 14 ± 2 |
| 104 | 10 ± 2 |

### It is preferred that the plastic shortening contain some mono or diglyceride emulsifying agent, and preferably from about 3.5% wt. to about 4% wt.

Numerous other ingredients may be used in the reduced-calorie icing compositions of the invention as known to those of skill in the art. For example, other typical ingredients include corn syrup solids, high fructose corn syrup, salt, flavoring, surfactants, coloring, polysorbate 60, gums, and the like.

The following examples are presented to illustrate the present invention and to assist one of ordinary skill in making and using the same. The examples are not intended in any way to limit the scope of the invention.

### EXAMPLES

### Stabilizer Solution:

Water was measured into a conventional mixing tank. The water was at a temperature of 110° F.±5° F. Next, the dry ingredients (i.e., corn syrup solids, salt, and xanthan gum) were slowly added to the mixing tank and mixing was continued until unifom. Next, the liquid ingredients were added to the to the mix tank in the following order: high fructose corn syrup, followed by a mixture of flavorings and polysorbate 60. The resulting stabilizer solution was mixed for 5 minutes maintaining a temperature within the range of about 85° F.±5° F.

### General Procedure I for Making Icing Composition Icing Composition:

An icing composition was prepared as follows. First, the formulation-required amounts of powdered sugar, dextrose, sweet whey, inulin, and shortening were added to a ribbon blender. The ingredients were blended on low speed for about 5 minutes. Next, with the mixer on low speed, about 45% of the formulation-required amount of stabilizer solution was added to the ribbon blender. The stabilizer solution was blended into the other ingredients at high speed for about 2 minutes. Next, the formulation-required amount of soybean oil was added to the ribbon blender. The soybean oil was mixed into the other ingredients for about 1 minute at high speed. Next, with the mixer on low speed, the remaining 55% of the formulation-required amount of stabilizer solution was added to the ribbon blender and the composition was mixed on high speed for 9±1 minutes. The final icing temperature was 85° F. or less.

### Example 1

An icing composition of the invention was prepared as described in the General Procedure 1. The stabilizer solution had the formula listed in TABLE 1. The icing composition had the formula listed in TABLE 2.

TABLE 1
Stabilizer Solution

| Ingredient | % Weight |
|---|---|
| Water | 69.13 |
| Corn syrup solids | 11.90 |
| Salt | 2.07 |
| Xanthan gum | 0.12 |
| High fructose corn | 16.20 |
| syrup | |
| Flavoring | 0.24 |
| Polysorbate 60 | 0.35 |

TABLE 2
Icing Composition

| Ingredient | % Weight |
|---|---|
| Powdered sugar | 45.66 |
| Dextrose | 1.90 |
| Shortening | 9.51 |
| Soybean oil | 5.33 |
| Sweet whey solids | 3.81 |
| Inulin | 11.72 |
| Stabilizer Solution | 22.07 |

Comments/Observations: The icing of Example 1 was observed to be stringy. Stringiness is not desirable because it may lead to improper sealing of icing pouches that are filled and sealed using an automated process. Specifically, when using an automated process, the flow of icing from the dispensing equipment preferably has a discrete cut-off in flow that is timed to occur between pouches. When the icing is stingy, the icing may continue to flow between pouches thereby coating a portion of the pouch that is later to be sealed. This coating may disrupt the proper sealing of the pouch. Relative to the control icing, the formulation of Example I had a blander flavor.

### Example 2

An icing composition of the invention was prepared as described in the General Procedure 1. The stabilizer solution had the formula listed in TABLE 3. The icing composition had the formula listed in TABLE 4.

TABLE 3
Stabilizer Solution

| Ingredient | % Weight |
|---|---|
| Water | 69.13 |
| Corn syrup solids | 11.87 |
| Salt | 2.06 |
| Xanthan gum | 0.12 |
| High fructose corn | 16.17 |
| syrup | |
| Flavoring | 0.32 |
| Polysorbate 60 | 0.34 |

TABLE 4
Icing Composition

| Ingredient | % Weight |
|---|---|
| Powdered sugar | 45.64 |
| Dextrose | 1.90 |
| Shortening | 9.51 |
| Soybean oil | 5.32 |
| Sweet whey solids | 3.80 |
| Inulin | 11.71 |
| Stabilizer Solution | 22.12 |

Comments/Observations: The formula was similar to Example 1 with an increase in flavoring to better match the flavor of the control icing. The mix time was increased to adjust for density and moisture. The product performed to Example 1.

### Example 3

An icing composition of the invention was prepared as described in the General Procedure 1. The stabilizer solution had the formula listed in TABLE 5. The icing composition had the formula listed in TABLE 6.

TABLE 5
Stabilizer Solution

| Ingredient | % Weight |
|---|---|
| Water | 69.50 |
| Corn syrup solids | 11.78 |
| Salt | 1.93 |
| Xanthan gum | 0.13 |
| High fructose corn | 16.02 |
| syrup | |
| Flavoring | 0.30 |
| Polysorbate 60 | 0.34 |

TABLE 6
Icing Composition

| Ingredient | % Weight |
|---|---|
| Powdered sugar | 46.26 |
| Dextrose | 2.01 |
| Shortening | 9.05 |
| Soybean oil | 5.43 |
| Sweet whey solids | 4.02 |
| Inulin | 12.39 |
| Stabilizer Solution | 20.84 |

Comments/Observations: The formula of Example 3 was adjusted to have a lower water level in order to adjust for the stringiness that was observed in Examples 1-2. This resulted in the icing becoming too thick and dense. When deposited in the pouch, the icing did not spread and, in some instances, did not allow the pouch to seal properly.

### Example 4

An icing composition of the invention was prepared as described in the General Procedure 1, except as noted below. The stabilizer solution had the formula listed in TABLE 7. The icing composition had the formula listed in TABLE 8.

TABLE 7
Stabilizer Solution

| Ingredient | % Weight |
|---|---|
| Water | 65.14 |
| Corn syrup solids | 13.70 |
| Salt | 2.38 |
| Xanthan gum | 0.14 |
| High fructose corn | 17.88 |
| syrup | |
| Flavoring | 0.36 |
| Polysorbate 60 | 0.40 |

TABLE 8
Icing Composition

| Ingredient | % Weight |
|---|---|
| Powdered sugar | 47.03 |
| Dextrose | 1.96 |
| Shortening | 9.80 |
| Soybean oil | 5.49 |
| Sweet whey solids | 3.92 |
| Inulin | 12.07 |
| Stabilizer Solution | 19.73 |

Comments/Observations: The ratio of water, inulin, and sugar were adjusted in Example 4 to provide acceptable density and moisture. An adjustment was also made to the mixing procedure to include a third mixing stage. The mixing procedure in this Example 4 was modified to add 50% of the stabilizer solution and the inulin as a second stage. In the third stage, the remaining 50% of the stabilizer solution was added and mixed to the proper moisture and density.

### Example 5

An icing composition of the invention was prepared as described in the General Procedure 1 as modified by Example 4. The stabilizer solution had the formula listed in TABLE 9. The icing composition had the formula listed in TABLE 10.

TABLE 9
Stabilizer Solution

| Ingredient | % Weight |
|---|---|
| Water | 64.35 |
| Corn syrup solids | 14.01 |
| Salt | 2.44 |
| Xanthan gum | 0.16 |
| High fructose corn | 18.27 |
| syrup | |
| Flavoring | 0.36 |
| Polysorbate 60 | 0.41 |

TABLE 10
Icing Composition

| Ingredient | % Weight |
|---|---|
| Powdered sugar | 47.23 |
| Dextrose | 1.97 |
| Shortening | 9.84 |
| Soybean oil | 5.51 |
| Sweet whey solids | 3.94 |
| Inulin | 12.12 |
| Stabilizer Solution | 19.39 |

### Comments/Observations: The icing was acceptable for commercial production.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following embodiments.

What is claimed is:

1. A reduced-calorie icing composition comprising inulin, sugar, gum, water, and fat; wherein the reduced-calorie icing has about 3.7 calories/gram or less.

2. The reduced-calorie icing composition of embodiment 1, wherein the icing can be dispensed by hand from a flexible pouch at a frozen temperature and is not runny at room temperature.

3. The reduced-calorie icing composition of embodiment 1, wherein the icing comprises about 10% wt. to about 15% wt. inulin; about 30% wt. to about 55% wt. sugar; about 0.009% to about 0.027% wt. xanthan gum; about 8% wt. to about 20% wt. water; and about 12% to about 20% wt. total fat.

4. The reduced-calorie icing of embodiment 1, wherein the icing has about 11% wt. to about 13% wt. inulin.

5. The reduced-calorie icing of embodiment 1, wherein the icing has about 40% wt. to about 50% wt. sugar.

6. The reduced-calorie icing of embodiment 1, wherein the icing comprises about 45% wt. to about 46% wt. sugar.

7. The reduced-calorie icing of embodiment 1, wherein the icing comprises about 0.010% wt. to about 0.015% wt. xanthan gun.

8. The reduced-calorie-icing of embodiment 1, wherein the icing comprises about 12% wt. to about 14% wt. water.

9. The reduced-calorie icing composition of embodiment 1, wherein the icing comprises about 14% wt. to about 16% wt. fat.

10. The reduced-calorie icing composition of embodiment 1, wherein the fat comprises a mixture of liquid oil and hydrogenated shortening.

11. The reduced-calorie icing composition of embodiment 10, wherein the liquid oil and hydrogenated shortening are provided in a ratio of liquid oil to liquid oil plus hydrogenated shortening ranging from about 0.26:1 to about 0.43 to 1.

12. The reduced-calorie icing composition of embodiment 11, wherein the hydrogenated shortening has a Wiley melting point of about 115° F.±5° F. and a solids fat index (SFI) of from about 23% to about 29% wt. at 50° F.; about 17% to about 23% wt. at 70° F.; about 12% to about 16% at 92° F.; and about 8% to about 12% at 104° F.

13. The reduced-calorie icing composition of embodiment 1, wherein the weight ratio of inulin to water ranges from about 10:8 to about 15:20.

14. The reduced-calorie icing composition of embodiment 1, wherein the inulin comprises short-chain inulin.

15. The reduced-calorie icing composition of embodiment 1, wherein the inulin has an average degree of polymerization of about 20 or less.

16. The reduced-calorie icing composition of embodiment 1, wherein the icing has a density of about 0.95 to about 1.15 grams/cm³.

17. The reduced-calorie icing composition of embodiment 1, wherein the icing has a density greater than 1.0 grams/cm³.

18. A food product comprising: (a) a pre-cooked pastry; and (b) a flexible pouch at least partially filled with a reduced-calorie icing composition comprising inulin, sugar, gum, water, and fat; wherein the reduced-calorie icing has about 3.7 calories/gram or less.

19. A reduced-calorie icing composition comprising:
about 10% wt. to about 15% wt. inulin;
about 30% wt. to about 55% wt. sugar;
about 0.009% to about 0.027% wt. xanthan gum;
about 8% wt. to about 20% wt. water;
about 12% to about 20% wt. total fat;
wherein the icing has about 3.7 calories/gram or less.

20. A reduced-calorie icing composition comprising:
about 10% wt. to about 15% wt. inulin comprising short chain inlulin having an average degree of polymerization of 20 or less;
about 30% wt. to about 55% wt. sugar;
about 0.009% to about 0.027% wt. xanthan gum;
about 8% wt. to about 20% wt. water;
about 12% to about 20% wt. total fat comprising a mixture of liquid oil and hydrogenated shortening; wherein the liquid oil and hydrogenated shortening are provided in a ratio of liquid oil to liquid oil plus hydrogenated shortening ranging from about 0.26:1 to about 0.43 to 1;
wherein the weight ratio of inulin to water ranges from about 10:8 to about 15:20; and wherein the reduced-calorie icing has about 3.7 calories/gram or less.
